(19) United States
(12) Patent Application Publication
(10) Pub. No.: US 2002/0022501 A1
(43) Pub. Date: Feb. 21, 2002

(54) Cellular phone apparatus and communication method therefor

(75) Inventor: Ryohei Sato, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/855,242

(22) Filed: May 15, 2001

(30) Foreign Application Priority Data
May 22, 2000 (JP) 150102/2000

(51) Int. Cl. H04M 1/00

(52) U.S. Cl. 455/557; 455/67.1

(57) ABSTRACT

A cellular telephone apparatus has a cellular telephone set capable of originating a plurality of calls to a base station and communicating with an accessory through sub-communication unit, and the accessory capable of communicating with the cellular telephone set through the sub-communication unit, and can execute a communication function other than a voice communication function by the cellular telephone set through the sub-communication unit. The apparatus includes a monitoring section for monitoring the channel quality of sub-communication between the cellular telephone set and the accessory during communication with a remote cellular telephone set by using the accessory, and a control section for, when the monitoring section determines that the channel quality of the sub-communication has deteriorated to a predetermined level or less, causing the cellular telephone set to start originating a call to the remote cellular telephone set. A communication method for a cellular telephone apparatus is also disclosed.

### BACKGROUND OF THE INVENTION

1. Field of the Invention

The present invention relates to a cellular phone apparatus which allows the use of other functions such as a videophone by equipping a cellular phone set with an accessory connected through a radio channel controlled independently of a speech channel in addition to a speech function, and a communication method for the apparatus.

2. Description of the Prior Art

Recently, a cellular phone apparatus having a videophone function and the like as well as a general speech function has been developed, which can simultaneously originate a plurality of calls and display images and the like sensed on the remote side by transmitting/receiving image signals and other information signals via other calls. Since a cellular phone set has a small screen, an apparatus having an image display unit independently of the cellular phone has been proposed. In this apparatus, the cellular phone set receives an image signal from the party on the other end and transmits the received image to the image display unit through a radio channel such as an infrared channel. With this operation, the image and the like received by the cellular phone set are displayed on the image display unit, thus implementing a videophone function.

The cellular phone set and image display unit communicate with each other and transfer information by using an infrared or consumer radio channel. If, however, an obstacle exists between them, the communication channel quality deteriorates, and image disturbances occur or the communication is interrupted, resulting in an inability to display images and the like.

In this case, in the conventional cellular phone apparatus in which communication channels for the cellular phone set and image display unit cannot be independently controlled, the cellular phone set cannot communicate with the remote cellular phone set, resulting in inconvenience in use.

### SUMMARY OF THE INVENTION

The present invention has been made to solve the above problems in the conventional cellular phone apparatus, and has as its object to provide a cellular phone apparatus which is configured to independently control communication channels for a cellular phone set and image display unit, thereby allowing the use of other functions such as a videophone function, and a communication method for the cellular phone apparatus.

In order to achieve the above object, according to the first aspect of the present invention, there is provided a cellular telephone apparatus which has a cellular telephone set capable of originating a plurality of calls to a base station and communicating with an accessory through sub-communication means, and the accessory capable of communicating with the cellular telephone set through the sub-communication means, and can execute a communication function other than a voice communication function by the cellular telephone set through the sub-communication means, comprising monitoring means for monitoring channel quality of sub-communication between the cellular telephone set and the accessory during communication with a remote cellular telephone set by using the accessory, and control means for, when the monitoring means determines that the channel quality of the sub-communication has deteriorated to not more than a predetermined level, causing the cellular telephone set to start originating a call to the remote cellular telephone set.

In order to achieve the above object, according to the second aspect of the present invention, there is provided a cellular telephone apparatus which has a cellular telephone set capable of originating a plurality of calls to a base station and communicating with an accessory through sub-communication means, and the accessory capable of communicating with the cellular telephone set through the sub-communication means, and can execute a communication function other than a voice communication function by the cellular telephone set through the sub-communication means, the cellular telephone set comprising cellular telephone transceiver means for originating a plurality of calls to a base station, sub-communication means for performing communication with the accessory, channel monitoring means for monitoring channel quality of the sub-communication means, and control means for, when the channel quality of the sub-communication means has deteriorated to not more than a predetermined level, causing the cellular telephone transceiver means to start originating a call for voice communication with a remote cellular telephone set, and the accessory comprises sub-communication means for performing communication with the cellular telephone set, expression means for expressing a content transferred by the sub-communication means, channel monitoring means for monitoring channel quality of the sub-communication means, and control means for, when the channel quality of the sub-communication means has deteriorated to not more than a predetermined level, notifying the cellular telephone set of the corresponding information.

The following secondary aspects can be added to the first and second aspects.

The accessory comprises a videophone or musical unit.

The sub-communication means comprises an infrared communication means or radio communication means.

In order to achieve the above object, according to the third aspect of the present invention, there is provided a communication method for a cellular telephone apparatus including a cellular telephone capable set of originating a call in addition to a call for voice communication, and an accessory capable of communicating with the cellular telephone set by using a radio channel for sub-communication, wherein even if channel quality of a radio channel for the sub-communication has deteriorated to not more than a predetermined level, when the cellular telephone set can perform voice communication with a remote cellular telephone set, the cellular telephone set is allowed to perform voice communication with the remote cellular telephone set.

According to-the cellular telephone apparatus of the present invention, even if the communication state between the cellular telephone set and the videophone unit connected thereto deteriorates and the videophone unit does not function as a videophone, the cellular telephone set is allowed to communicate with a remote cellular telephone set by originating a call for voice communication other than the call in use. This prevents abrupt interruption of communication between the cellular telephone set and the remote cellular telephone set even when the videophone function fails for some reason, and can ensure at least voice communication with the remote cellular telephone set by using the telephone function. After the communication state is restored, videophone communication may be continued. If the communication state is not restored, the videophone function may be stopped.

As is obvious from the above aspects, according to the cellular telephone apparatus of the present invention which includes a cellular telephone set capable of originating a plurality of calls and an accessory such as a display unit capable of communicating with the cellular telephone set by radio, and causes the accessory to display an image or the like, when the communication state between the cellular telephone set and the accessory deteriorates, the cellular telephone set can start voice communication with a remote cellular telephone set by originating a call. This makes it possible to ensure voice communication with the remote cellular telephone set even if the communication quality between the cellular telephone set and the accessory deteriorates during communication by using a communication channel other than a channel for voice communication.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a block diagram showing the schematic arrangement of a cellular phone apparatus according to the present invention;

FIG. 2 is a schematic view showing the overall arrangement of a communication system associated with the cellular phone apparatus of the present invention;

FIG. 3 is a flow chart showing the operation of the cellular phone apparatus of the present invention; and

FIG. 4 is a flow chart showing the operation of a display unit.

### DETAILED DESCRIPTION OF PREFERRED EMBODIMENT

A cellular phone apparatus according to an embodiment of the present invention will be described as an example of a cellular phone apparatus having a videophone function with reference to the accompanying drawings.

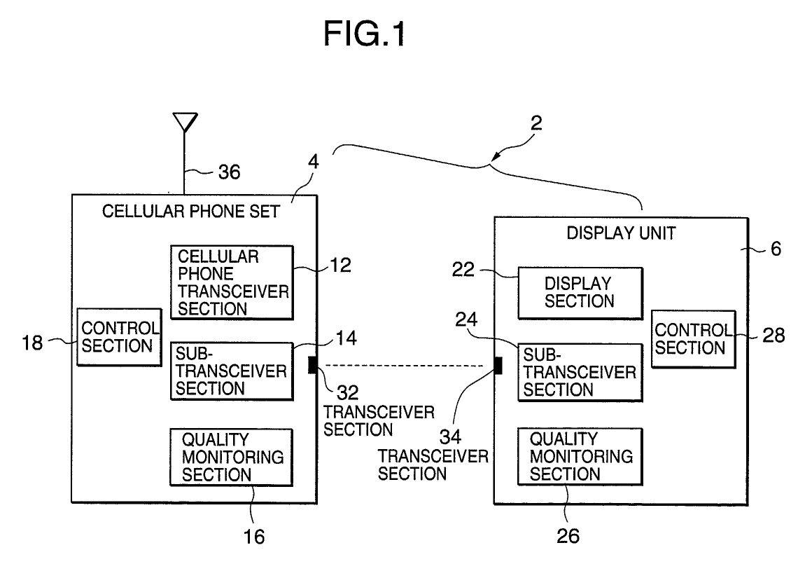

A cellular phone apparatus 2 of the present invention is comprised of a cellular phone set 4 and a display unit 6 as an accessory, as shown in FIG. 1.

The cellular phone set 4 has a CDMA (code Division Multiple Access) communication means using a spread spectrum technique with a predetermined code, can perform communications as well as voice communication by using a plurality of calls (channels). The cellular phone set 4 can therefore simultaneously perform a voice communication and a communication based on a videophone function or the like with a remote cellular phone set 40.

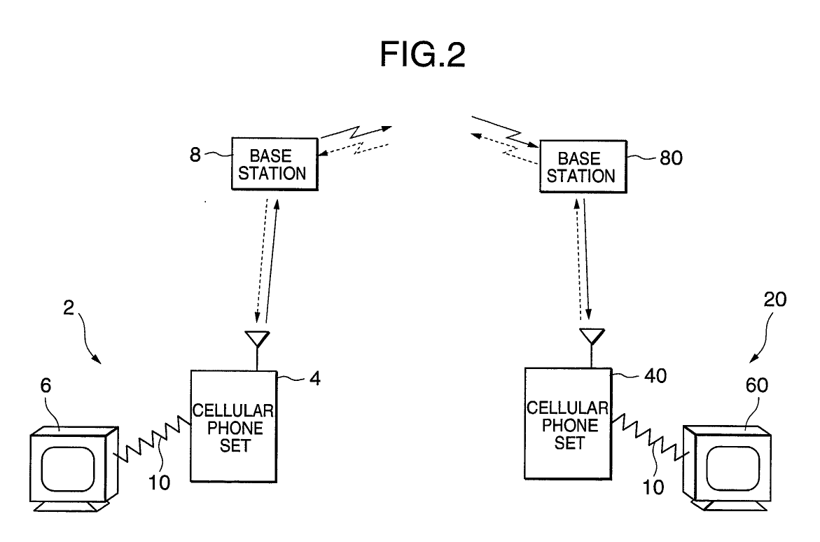

The cellular phone set 4 includes a cellular phone transceiver section 12 for communication between an antenna 36 and a base station 8 (FIG. 2), a sub-transceiver section 14 serving as a sub-communication unit, a quality monitoring section 16 serving as a channel monitoring unit, a transceiver section 32 for receiving/emitting infrared light, a control section 18, and the like. The cellular phone set 4 can perform general communication with the base station 8 through the cellular phone transceiver section 12, and information transfer to/from the display unit 6 by infrared communication through the sub-transceiver section 14 serving as a sub-communication unit, the transceiver section 32, and the like.

The quality monitoring section 16 detects channel quality from an error rate or the like while the cellular phone set 4 communicates with the display unit 6. Upon determining that the channel quality deteriorates to a predetermined level or less, the quality monitoring section 16 sends out the result signal to the control section 18. Upon reception of the signal indicating that the channel quality has deteriorated to the predetermined level or less, the control section 18 originates a call, other than a call which is used by the cellular phone transceiver section 12 to perform videophone communication with the party on the other end, to the remote cellular phone set 40 (see FIG. 2) to establish voice communication with the remote cellular phone set 40. Upon detecting that the channel quality is not restored, the control section 18 sends a sub-communication stop signal to the display unit 6 to stop the sub-communication.

The display unit 6 includes a display section 22 serving as an expression means formed by a liquid crystal display, CRT, or the like, an input section such as a ten-key pad, a speaker, an image sensing camera or the like (not shown), a sub-transceiver section 24 serving as a sub-communication unit, a quality monitoring section 26 serving as a channel monitoring unit, a transceiver section 34 for receiving/emitting infrared light, a control section 28, and the like. The display unit 6 can communicate with the cellular phone set 4 through infrared light.

The display section 22 displays images (including voice and the like) sent from the cellular phone set 4 through infrared light or outputs sounds. The image sensing camera senses an image and sends the image to the cellular phone set 4 by infrared light through the control section 28. The quality monitoring section 26 detects channel quality by error rate detection or the like during communication with the cellular phone set 4. Upon detecting that the channel quality has deteriorated to a predetermined level or less, the quality monitoring section 26 sends the corresponding information to the control section 28. The control section 28 then sends out the information to the cellular phone set 4. Upon reception of a signal to stop sub-communication from the cellular phone set 4, the control section 28 stops sub-communication (i.e., image display, image sensing, or the like) by infrared light.

As the transceiver sections 32 and 34, other radio communication media (media based on forms different from that used by the cellular phone set 4 for communication with the base station 8, e.g., consumer radio units) other than infrared communication media can be used.

As described above, the cellular phone apparatus 2 of the present invention can transmit/receive images, data, and the like by using a call other than a call for voice communication. To perform videophone communication with the remote cellular phone set 40, the cellular phone apparatus 2 establishes a channel between the cellular phone set 4 and the base station 8 and transmits/receives image signals to/from the remote cellular phone set 40 over the channel. At the same time, communication between the display unit 6 and a display unit 60 is performed by using infrared light (or another communication medium) to display images from the two parties on the display sections 22 of the display units 6 and 60, respectively.

If the channel state of communication between the display unit 6 (or 60) and the cellular phone set 4 (or 40) deteriorates to a predetermined level or less, the communication between the two cellular phones is ensured by a general speech channel before the image displayed on the display section 22 becomes extremely disturbed or no image is displayed to fail videophone communication.

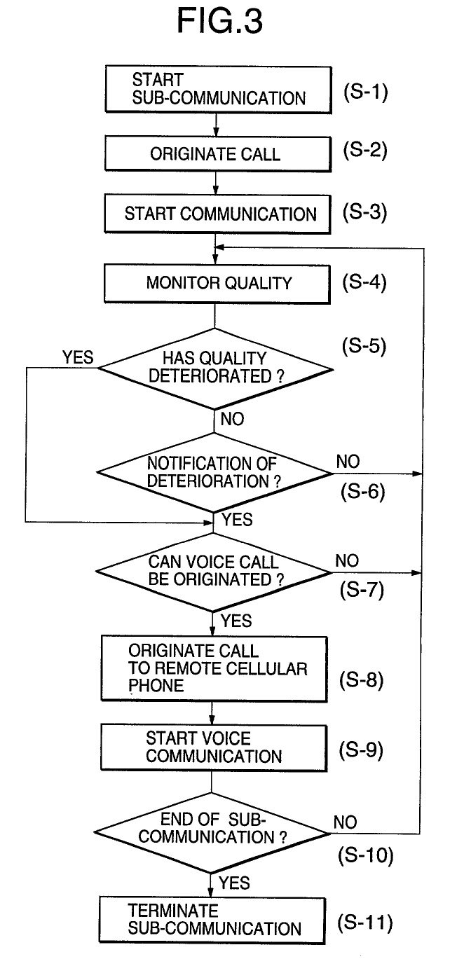

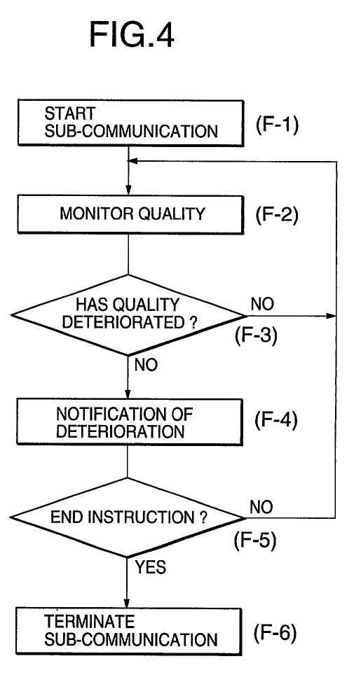

The operation of the cellular phone apparatus 2 of the present invention will be described next with reference to the flow charts of FIGS. 3 and 4.

First of all, the user inputs the telephone number of the remote cellular phone set 40 by operating the ten-key pad or the like provided for the display unit 6, and starts sub-communication (step F-1 in FIG. 4). The display unit 6 then transmits the corresponding information to the cellular phone set 4 through infrared light (step S-1 in FIG. 3), and the cellular phone set 4 originates a call in accordance with the instruction received from the display unit 6 (step S-2 in FIG. 3). The call from the cellular phone set 4 starts communication with the remote base station apparatus 20 through the base stations 8 and 80 (step S-3 in FIG. 3), and also activates the display units 6 and 60 to transmit/receive a sensed image signal and the like and display the corresponding images, thereby performing videophone communication.

The cellular phone set 4 causes the quality monitoring section 16 to always monitor the channel quality of sub-communication performed between the cellular phone set 4 and the display unit 6 (step S-4 in FIG. 3). For example, upon determining that the channel quality has deteriorated to the predetermined level or less (step S-5 in FIG. 3), or reception of a notification indicating that the channel quality has deteriorated to the predetermined level or less from the display unit 6 (step S-6 in FIG. 3), the cellular phone set 4 checks whether communication using a voice call can be performed with the remote cellular phone set 40 (step S-7 in FIG. 3). If the communication can be performed, the cellular phone set 4 originates a call to the remote cellular phone set 40 (step S-8 in FIG. 3).

Although the cellular phone set 4 originates a voice call to the remote cellular phone set 40 with which the cellular phone set 4 performs videophone communication, the cellular phone set 4 spreads voice by using a code different from the code used for videophone communication, i.e., image communication, so as to establish voice communication with the remote cellular phone set 40 by using another call. If a plurality of modulation/demodulation functions are prepared, a plurality of calls may be established by a conventional modulation/demodulation technique.

If a voice call is originated, i.e., a speech channel is established, voice communication is started (step S-9 in FIG. 3). Whether to terminate sub-communication is determined from a deterioration in quality (step S-10 in FIG. 3). If the deterioration is not improved, the sub-communication is terminated (step S-1 in FIG. 3).

As shown in FIG. 4, when sub-communication is started (step F-1), the display unit displays an image sent through the sub-communication on the display section 22 (step F-2). If no deterioration in quality occurs, the communication is maintained. If the deterioration becomes a predetermined level or more (step F-3), the corresponding information is sent to the control section 28. The control section 28 causes the sub-transceiver section 24 to notify the cellular phone set 4 of the information (step F-4). When the cellular phone set 4 outputs a notification indicating that the sub-communication should be terminated (step F-5), the control section 28 terminates the sub-communication (step F-6).

Even if, therefore, the videophone communication quality deteriorates in either of the cellular phone apparatuses 2, voice communication between the cellular phone sets 4 and 40 is ensured.

The accessory for the cellular phone apparatus 2 is not limited to a videophone display unit, and a unit using a musical function or the like may be used. In addition, when channel quality between the display units 6 and 60 deteriorates, character communication for displaying characters on the display screens of the cellular phone sets 4 an 40 or the like may be established instead of voice communication between the cellular phone sets 4 and 40.

What is claimed is:

1. A cellular telephone apparatus which has a cellular telephone set capable of originating a plurality of calls to a base station and communicating with an accessory through sub-communication means, and said accessory capable of communicating with said cellular telephone set through said sub-communication means, and can execute a communication function other than a voice communication function by said cellular telephone through said sub-communication means, comprising:
monitoring means for monitoring channel quality of sub-communication between said cellular telephone set and said accessory during communication with a remote cellular telephone set by using said accessory; and
control means for, when said monitoring means determines that the channel quality of the sub-communication has deteriorated to not more than a predetermined level, causing said cellular telephone set to start originating a call to the remote cellular telephone set.

2. An apparatus according to claim 1, wherein said accessory comprises a videophone unit.

3. An apparatus according to claim 1, wherein said accessory comprises a musical unit.

4. An apparatus according to claim 1, wherein said sub-communication means is infrared communication.

5. An apparatus according to claim 2, wherein said sub-communication means is infrared communication.

6. An apparatus according to claim 3, wherein said sub-communication means is infrared communication.

7. An apparatus according to claim 1, wherein said sub-communication means is radio communication.

8. An apparatus according to claim 2, wherein said sub-communication means is radio communication.

9. An apparatus according to claim 3, wherein said sub-communication means is radio communication.

10. A cellular telephone apparatus which has a cellular telephone set capable of originating a plurality of calls to a base station and communicating with an accessory through sub-communication means, and said accessory capable of communicating with said cellular telephone set through said sub-communication means, and can execute a communication function other than a voice communication function by said cellular telephone set through said sub-communication means,
said cellular telephone set comprising:
cellular telephone transceiver means for originating a plurality of calls to a base station;
sub-communication means for performing communication with said accessory;
channel monitoring means for monitoring channel quality of said sub-communication means; and
control means for, when the channel quality of said sub-communication means has deteriorated to not more than a predetermined level, causing said cellular telephone transceiver means to start originating a call for voice communication with a remote cellular telephone set, and
said accessory comprises:
sub-communication means for performing communication with said cellular telephone set;
expression means for expressing a content transferred by said sub-communication means;
channel monitoring means for monitoring channel quality of said sub-communication means; and
control means for, when the channel quality of said sub-communication means has deteriorated to not more than a predetermined level, notifying said cellular telephone set of the corresponding information.

11. An apparatus according to claim 10, wherein said accessory comprises a videophone unit.

12. An apparatus according to claim 10, wherein said accessory comprises a musical unit.

13. An apparatus according to claim 10, wherein said sub-communication means is infrared communication.

14. An apparatus according to claim 11, wherein said sub-communication means is infrared communication.

15. An apparatus according to claim 12, wherein said sub-communication means is infrared communication.

16. An apparatus according to claim 10, wherein said sub-communication means is radio communication.

17. An apparatus according to claim 11, wherein said sub-communication means is radio communication.

18. An apparatus according to claim 12, wherein said sub-communication means is radio communication.

19. A communication method for a cellular telephone apparatus including a cellular telephone set capable of originating a call in addition to a call for voice communication, and an accessory capable of communicating with the cellular telephone set by using a radio channel for sub-communication, wherein even if channel quality of a radio channel for the sub-communication has deteriorated to not more than a predetermined level, when the cellular telephone set can perform voice communication with a remote cellular telephone set, the cellular telephone set is allowed to perform voice communication with the remote cellular telephone set.
